(19) United States
(12) Patent Application Publication
(10) Pub. No.: US 2009/0150640 A1
(43) Pub. Date: Jun. 11, 2009

(54) Balancing Computer Memory Among a Plurality of Logical Partitions On a Computing System

(76) Inventors: Steven E. Royer, Rochester, MN (US); Craig A. Wilcox, Sun Prairie, WI (US)

Correspondence Address: IBM (ROC-BLF), C/O BIGGERS & OHANIAN, LLP, P.O. BOX 1469, AUSTIN, TX, 78767-1469, US

(21) Appl. No.: 11/954,114

(22) Filed: Dec. 11, 2007

(51) Int. Cl. G06F 12/02; G06F 12/00

(52) U.S. Cl. 711/173; 711/E12.002; 711/E12.084

(57) ABSTRACT

Methods, apparatus, and products are disclosed for balancing computer memory among a plurality of logical partitions on a computing system, the computing system having installed upon it a hypervisor, the hypervisor having allocated computer memory and computer storage to each of the logical partitions, that include: receiving, in a memory balancing module, a storage identifier for each logical partition, the storage identifier specifying a portion of a logical partition's allocated computer storage to be used for caching data contained in the logical partition's allocated computer memory; monitoring, by the memory balancing module for each logical partition, a storage usage rate for the portion of that logical partition's allocated computer storage specified by that logical partition's storage identifier; and instructing, by the memory balancing module, the hypervisor to reallocate the computer memory for two or more of the logical partitions in dependence upon the storage usage rates.

### BACKGROUND OF THE INVENTION

1. Field of the Invention

The field of the invention is data processing, or, more specifically, methods, apparatus, and products for balancing computer memory among a plurality of logical partitions on a computing system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area in which computer software has evolved to take advantage of high performance hardware is a software tool referred to as a ‘hypervisor.’ A hypervisor is a layer of system software that runs on the computer hardware beneath the operating system layer to allows multiple operating systems to run on a host computer at the same time. Hypervisors were originally developed in the early 1970's, when company cost reductions were forcing multiple scattered departmental computers to be consolidated into a single, larger computer—the mainframe—that would serve multiple departments. By running multiple operating systems simultaneously, the hypervisor brought a measure of robustness and stability to the system. Even if one operating system crashed, the others would continue working without interruption. Indeed, this even allowed beta or experimental versions of the operating system to be deployed and debugged without jeopardizing the stable main production system and without requiring costly second and third systems for developers to work on.

A hypervisor allows multiple operating systems to run on a host computer at the same time by providing each operating system with its own set of computer resources. These computer resources are typically virtualized counterparts to the physical resources of a computing system. A hypervisor allocates these resources to each operating system using logical partitions. A logical partition is a set of data structures and services that enables distribution of computer resources within a single computer to make the computer function as if it were two or more independent computers. Using a logical partition, therefore, a hypervisor provides a layer of abstraction between a computer hardware layer of a computing system and an operating system layer.

Although a hypervisor provides added flexibility in utilizing computer hardware, utilizing a hypervisor does have drawbacks. When a hypervisor provides resources to multiple operating systems through each operating system's logical partition, the resources may not be adequately distributed among the logical partitions to optimize resource utilization across all the operating systems. For example, the computer memory of a computing system may be allocated among several logical partitions in such a manner that one of operating systems is allocated more than enough computer memory resources to operate efficiently, while the other operating systems are allocated smaller amounts of computer memory resources that results in inefficient operations. As such, readers will appreciate that room for improvement exists for balancing computer memory among a plurality of logical partitions on a computing system.

### SUMMARY OF THE INVENTION

Methods, apparatus, and products are disclosed for balancing computer memory among a plurality of logical partitions on a computing system, the computing system having installed upon it a hypervisor, the hypervisor having allocated computer memory and computer storage to each of the logical partitions, that include: receiving, in a memory balancing module, a storage identifier for each logical partition, the storage identifier specifying a portion of a logical partition's allocated computer storage to be used for caching data contained in the logical partition's allocated computer memory; monitoring, by the memory balancing module for each logical partition, a storage usage rate for the portion of that logical partition's allocated computer storage specified by that logical partition's storage identifier; and instructing, by the memory balancing module, the hypervisor to reallocate the computer memory for two or more of the logical partitions in dependence upon the storage usage rates.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary computing system for balancing computer memory among a plurality of logical partitions on the computing system according to embodiments of the present invention.

FIG. 2 sets forth a block diagram of automated computing machinery comprising an exemplary computing system useful in balancing computer memory among a plurality of logical partitions on the computing system according to embodiments of the present invention.

FIG. 3 sets forth a flow chart illustrating an exemplary method for balancing computer memory among a plurality of logical partitions on a computing system according to embodiments of the present invention.

FIG. 4 sets forth a flow chart illustrating a further exemplary method for balancing computer memory among a plurality of logical partitions on a computing system according to embodiments of the present invention.

### DETAILED DESCRIPTION OF EXEMPLARY EMBODIMENTS

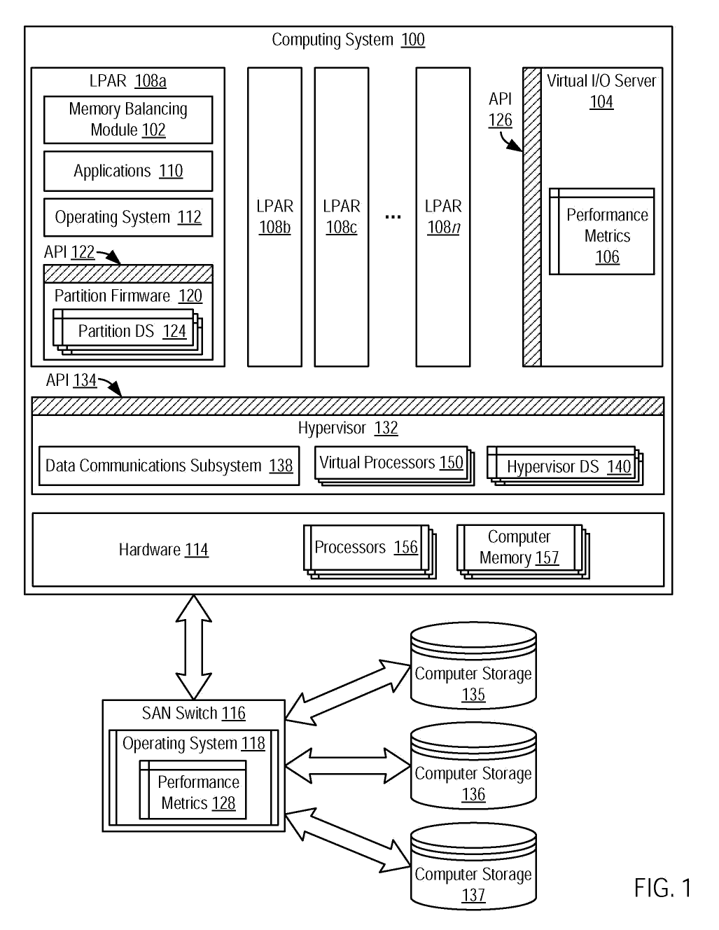

Exemplary methods, apparatus, and products for balancing computer memory among a plurality of logical partitions on a computing system in accordance with the present invention are described with reference to the accompanying drawings, beginning with FIG. 1. FIG. 1 sets forth a block diagram of an exemplary computing system (100) for balancing computer memory among a plurality of logical partitions on the computing system according to embodiments of the present invention. The exemplary computing system (100) of FIG. 1 balances computer memory among a plurality of logical partitions on the computing system according to embodiments of the present invention as follows: The computing system (100) has installed upon it a hypervisor (132). The hypervisor (132) has allocated computer memory (157) and computer storage (135, 136, 137) to each of the logical partitions (108). A memory balancing module (102) receives a storage identifier for each logical partition (108). The storage identifier specifies a portion of a logical partition's allocated computer storage to be used for caching data contained in the logical partition's allocated computer memory. For each logical partition (108), the memory balancing module (102) monitors a storage usage rate for the portion of that logical partition's allocated computer storage specified by that logical partition's storage identifier. The memory balancing module (102) then instructs the hypervisor (132) to reallocate the computer memory (157) for two or more of the logical partitions (108) in dependence upon the storage usage rates.

In the example of FIG. 1, the computing system (100) includes logical partitions (108). Each logical partition (108) provides an execution environment for applications and an operating system. In the example of FIG. 1, the logical partition (108a) provides an execution environment for applications (110) and operating system (112). Each application (110) is a set of computer program instructions implementing user-level data processing. The operating system (112) of FIG. 1 is system software that manages the resources allocated to the logical partition (108a) by the hypervisor (132). The operating system (112) performs basic tasks such as, for example, controlling and allocating virtual memory, prioritizing the processing of instructions, controlling virtualized input and output devices, facilitating networking, and managing a virtualized file system.

The hypervisor (132) of FIG. 1 is a layer of system software that runs on the computer hardware (114) beneath the operating system layer to allow multiple operating systems to run on a host computer at the same time. The hypervisor (132) provides each operating system with a set of computer resources using the logical partitions (108). A logical partition (‘LPAR’) is a set of data structures and services provided to a single operating system that enables the operating system to run concurrently with other operating systems on the same computer hardware. In effect, the logical partitions allow the distribution of computer resources within a single computer to make the computer function as if it were two or more independent computers.

The hypervisor (132) of FIG. 1 establishes each logical partition using a combination of data structures and services provided by the hypervisor (132) itself along with partition firmware configured for each logical partition. In the example of FIG. 1, the logical partition (108a) is configured using partition firmware (120). The partition firmware (120) of FIG. 1 is system software specific to the partition (108a) that is often referred to as a ‘dispatchable hypervisor.’ The partition firmware (120) maintains partition-specific data structures (124) and provides partition-specific services to the operating system (112) through application programming interface (‘API’) (122). The hypervisor (132) maintains data structures (140) and provides services to the operating systems and partition firmware for each partition through API (134). Collectively, the hypervisor (132) and the partition firmware (120) are referred to in this specification as ‘firmware’ because both the hypervisor (132) and the partition firmware (120) are typically implemented as firmware. Together the hypervisor (132) and the partition firmware enforce logical partitioning between one or more operating systems by storing state values in various hardware registers and other structures, which define the boundaries and behavior of the logical partitions. Using such state data, the hypervisor (132) and the partition firmware may allocate memory to logical partitions, route input/output between input/output devices and associated logical partitions, provide processor-related services to logical partition, and so on. Essentially, this state data defines the allocation of resources in logical partitions, and the allocation is altered by changes the state data rather than by physical reconfiguration of hardware.

In order to allow multiple operating systems to run at the same time, the hypervisor (132) assigns virtual processors (150) to the operating systems running in the logical partitions (108) and schedules virtual processors (150) on one or more physical processors (156) of the computing system (100). A virtual processor is a subsystem that implements assignment of processor time to a logical partition. A shared pool of physical processors (156) supports the assignment of partial physical processors (in time slices) to each logical partition. Such partial physical processors shared in time slices are referred to as ‘virtual processors.’ A thread of execution is said to run on a virtual processor when it is running on the virtual processor's time slice of the physical processors. Sub-processor partitions time-share a physical processor among a set of virtual processors, in a manner that is invisible to an operating system running in a logical partition. Unlike multiprogramming within the operating system where a thread can remain in control of the physical processor by running the physical processor in interrupt-disabled mode, in sub-processor partitions, the thread is still pre-empted by the hypervisor (132) at the end of its virtual processor's time slice, in order to make the physical processor available to a different virtual processor.

The hypervisor (132) of FIG. 1 includes a data communications subsystem (138) for implementing data communication with other computing devices connected to the computing system (100). In particular, the data communications subsystem (138) of FIG. 1 implements data communications with the computer storage (135, 136, 137) through a Storage Area Network (‘SAN’) switch (116). The data communications subsystem (138) may implement such data communications using Fibre Channel over IP (‘FCIP’), also referred to as Fibre Channel tunneling or storage tunneling. FCIP is a method for allowing the transmission of Fibre Channel information to be tunneled through an IP network. The data communications subsystem (138) may also implement data communications with the computer storage (135, 136, 137) according to the Internet Fibre Channel Protocol (‘iFCP’), which is a mechanism for transmitting data to and from Fibre Channel storage devices in a SAN, or on the Internet using TCP/IP. Readers will note that implementing data communication between the computing system (100) and computer storage (135, 136, 137) through SAN switch (116) using FCIP or iFCP is for explanation only and not for limitation. In fact, the data communications subsystem (138) may implement data communications with the computer storage (135, 136, 137) in any manner as will occur to those of skill in the art, including for example, the Internet SCSI (‘iSCSI’) transport protocol. iSCSI is a data storage networking protocol that transports standard Small Computer System Interface (‘SCSI’) requests over the standard Transmission Control Protocol/Internet Protocol (‘TCP/IP’) networking technology. The SAN switch (116) of FIG. 1 is a computer networking device that connects the computing system (100) with one or more computer storage devices (135, 136, 137) to form a Storage Area Network. The SAN switch (116) is capable of inspecting data packets as they are received, determining the source and destination device of each packet, and forwarding that packet to the appropriate device. By delivering each packet only to the device for which that packet was intended, a SAN switch conserves network bandwidth and offers generally better performance than a hub. The computer storage (135, 136, 137) that the SAN switch (116) connects to the computing system (100) may be implemented as disk storage systems such as, for example, Just A Bunch of Disk (‘JBOD’) systems or Redundant Array of Independent Disks (‘RAID’) systems. The computer storage (135, 136, 137) may also be implemented as tape storage systems such as, for example, tape drives, tape autoloaders, and tape libraries. Such exemplary computer storage systems are for explanation only, not for limitation. In fact, the computer storage (135, 136, 137) may be implemented in any manner as will occur to those of skill in the art.

In the example of FIG. 1, the SAN switch (116) has installed upon it an operating system (118) used to manage and configure the SAN switch (116). The operating system (118) of FIG. 1 maintains performance metrics (128) in an operating system table. The performance metrics (128) of FIG. 1 includes such performance statistics such as, for example, the storage usage rates for various portions of the computer storage (135, 136, 137). The storage usage rates may be implemented as the read rate or write rate for a particular portion of storage contained in the computer storage (135, 136, 137). The read rate may represent the amount of data read from a particular portion of the computer storage (135, 136, 137) over a particular time period, while the write may represent the amount of data written to a particular portion of the computer storage (135, 136, 137) over a particular time period.

In the example of FIG. 1, the computing system (100) has installed upon it a virtual I/O server (104). The virtual I/O server (104) is computer software that facilitates the sharing of physical I/O resources between logical partitions (108) within the computer system (100). The virtual I/O server provides virtual storage adapter and network adapter capability to logical partitions within the system (100), allowing the logical partitions (108) to share computer storage devices and network adapters. The virtual I/O server (104) of FIG. 1 includes performance metrics (106). Similar to the performance metrics (118) stored in the SAN switch (116), the performance metrics (118) of FIG. 1 includes such performance statistics such as, for example, the storage usage rates for various portions of the computer storage (135, 136, 137). The storage usage rates may be implemented as the read rate or write rate for a particular portion of storage contained in the computer storage (135, 136, 137). The virtual I/O server (104) provides the logical partitions (108) access to the performance metrics (106) and virtualized storage and network resources through an API (126). Readers will note that examples of a virtual I/O server may include IBM's Virtual I/O Server.

In the exemplary computing system (100) of FIG. 1, the logical partition (108a) includes a memory balancing module (102). The memory balancing module (102) is computer software that includes a set of computer program instructions for balancing computer memory among a plurality of logical partitions on a computing system according to embodiments of the present invention. The memory balancing module (102) generally operates to balance computer memory among a plurality of logical partitions on a computing system according to embodiments of the present invention by: receiving a storage identifier for each logical partition (108), the storage identifier specifying a portion of a logical partition's allocated computer storage to be used for caching data contained in the logical partition's allocated computer memory; monitoring, for each logical partition (108), a storage usage rate for the portion of that logical partition's allocated computer storage (135, 136, 137) specified by that logical partition's storage identifier; and instructing the hypervisor (132) to reallocate the computer memory (157) for two or more of the logical partitions (108) in dependence upon the storage usage rates.

Although FIG. 1 illustrates the memory balancing module (102) in the logical partition (108a), readers will note that such an example is for explanation and not for limitation. In fact, the memory balancing module (102) may be executed in any of the logical partitions (108). In some embodiments, the memory balancing module (102) may be executed remotely on another computing device network-connected to the computing system (100).

In the example of FIG. 1, the exemplary computing system (100) may be implemented as a blade server installed in a computer rack along with other blade servers. Each blade server includes one or more computer processors and computer memory operatively coupled to the computer processors. The blade servers are typically installed in server chassis that is, in turn, mounted on a computer rack. Readers will note that implementing the computing system (100) as blade server is for explanation and not for limitation. In fact, the computing system of FIG. 1 may be implemented as a workstation, a node of a computer cluster, a compute node in a parallel computer, or any other implementation as will occur to those of skill in the art.

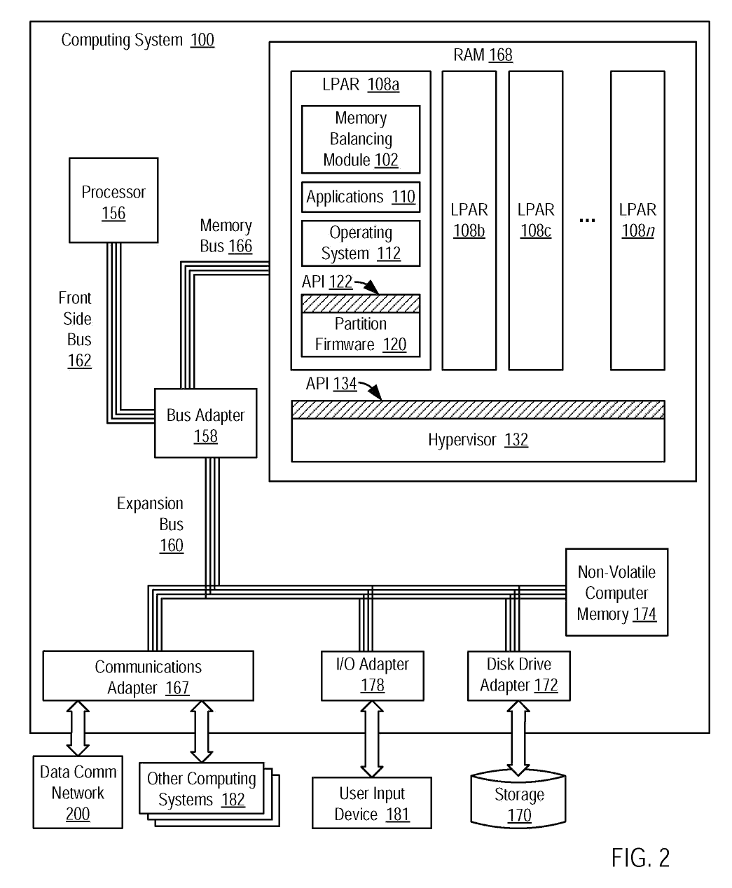

Balancing computer memory among a plurality of logical partitions on a computing system in accordance with the present invention is generally implemented with computers, that is, with automated computing machinery. In FIG. 1, for example, the computing system, the SAN switch, and the computer storage are implemented to some extent at least as computers. For further explanation, therefore, FIG. 2 sets forth a block diagram of automated computing machinery comprising an exemplary computing system (100) useful in balancing computer memory among a plurality of logical partitions on the computing system according to embodiments of the present invention. The computing system (100) of FIG. 2 includes at least one computer processor (156) or ‘CPU’ as well as random access memory (168) (‘RAM’) which is connected through a high speed memory bus (166) and bus adapter (158) to processor (156) and to other components of the computing system.

Stored in RAM (168) are logical partitions (108) and a hypervisor (132) that exposes an API (134). Each logical partition (108) is a set of data structures and services that enables distribution of computer resources within a single computer to make the computer function as if it were two or more independent computers. Logical partition (108a) includes application (110), an operating system (112), and partition firmware that exposes an API (122). Operating systems useful in computing systems according to embodiments of the present invention include UNIX™, Linux™, Microsoft Vista™, IBM's AIX™, IBM's i5/OS™, and others as will occur to those of skill in the art.

In the example of FIG. 2, the logical partition (108a) includes a memory balancing module (102). The memory balancing module (102) of FIG. 2 is a set of computer program instructions that balance computer memory among a plurality of logical partitions (108) on the computing system (100) according to embodiments of the present invention. The memory balancing module (102) of FIG. 2 operates generally to balance computer memory among a plurality of logical partitions (108) on the computing system (100) according to embodiments of the present invention by: receiving a storage identifier for each logical partition (108), the storage identifier specifying a portion of a logical partition's allocated computer storage to be used for caching data contained in the logical partition's allocated computer memory; monitoring, for each logical partition (108), a storage usage rate for the portion of that logical partition's allocated computer storage specified by that logical partition's storage identifier; and instructing the hypervisor to reallocate the computer memory for two or more of the logical partitions (108) in dependence upon the storage usage rates.

The hypervisor (132) and the logical partitions (108), including memory balancing module (102), applications (110), the operating system (112), the partition firmware (120) illustrated in FIG. 2 are software components, that is computer program instructions and data structures, that operate as described above with reference to FIG. 1. The hypervisor (132) and the logical partitions (108), including memory balancing module (102), applications (110), the operating system (112), the partition firmware (120) in the example of FIG. 2 are shown in RAM (168), but many components of such software typically are stored in non-volatile computer memory (174) or computer storage (170).

The exemplary computing system (100) of FIG. 2 includes bus adapter (158), a computer hardware component that contains drive electronics for high speed buses, the front side bus (162) and the memory bus (166), as well as drive electronics for the slower expansion bus (160). Examples of bus adapters useful in computing systems useful according to embodiments of the present invention include the Intel Northbridge, the Intel Memory Controller Hub, the Intel Southbridge, and the Intel I/O Controller Hub. Examples of expansion buses useful in computing systems useful according to embodiments of the present invention may include Peripheral Component Interconnect (‘PCI’) buses and PCI Express (‘PCIe’) buses.

Although not depicted in the exemplary computing system (100) of FIG. 2, the bus adapter (158) may also include drive electronics for a video bus that supports data communication between a video adapter and the other components of the computing system (100). FIG. 2 does not depict such video components because a computing system is often implemented as a blade server installed in a server chassis or a node in a parallel computer with no dedicated video support. Readers will note, however, that computing systems useful in embodiments of the present invention may include such video components.

The exemplary computing system (100) of FIG. 2 also includes disk drive adapter (172) coupled through expansion bus (160) and bus adapter (158) to processor (156) and other components of the exemplary computing system (100). Disk drive adapter (172) connects non-volatile data storage to the exemplary computing system (100) in the form of disk drive (170). Disk drive adapters useful in computing systems include Integrated Drive Electronics (‘IDE’) adapters, Small Computer System Interface (‘SCSI’) adapters, and others as will occur to those of skill in the art. In the exemplary computing system (100) of FIG. 2, non-volatile computer memory (174) is connected to the other components of the computing system (100) through the bus adapter (158). In addition, the non-volatile computer memory (174) may be implemented for a computing system as an optical disk drive, electrically erasable programmable read-only memory (so-called ‘EEPROM’ or ‘Flash’ memory), RAM drives, and so on, as will occur to those of skill in the art.

The exemplary computing system (100) of FIG. 2 includes one or more input/output (‘I/O’) adapters (178). I/O adapters in computing systems implement user-oriented input/output through, for example, software drivers and computer hardware for controlling output to display devices such as computer display screens, as well as user input from user input devices (181) such as keyboards and mice. Although not depicted in the example of FIG. 2, computing systems in other embodiments of the present invention may include a video adapter, which is an example of an I/O adapter specially designed for graphic output to a display device such as a display screen or computer monitor. A video adapter is typically connected to processor (156) through a high speed video bus, bus adapter (158), and the front side bus (162), which is also a high speed bus.

The exemplary computing system (100) of FIG. 2 includes a communications adapter (167) for data communications with other computing systems (182) and for data communications with a data communications network (200). Such data communications may be carried out through Ethernet connections, through external buses such as a Universal Serial Bus (‘USB’), through data communications networks such as IP data communications networks, and in other ways as will occur to those of skill in the art. Communications adapters implement the hardware level of data communications through which one computing system sends data communications to another computing system, directly or through a data communications network. Examples of communications adapters useful for balancing computer memory among a plurality of logical partitions on a computing system according to embodiments of the present invention include modems for wired dial-up communications, IEEE 802.3 Ethernet adapters for wired data communications network communications, and IEEE 802.11b adapters for wireless data communications network communications.

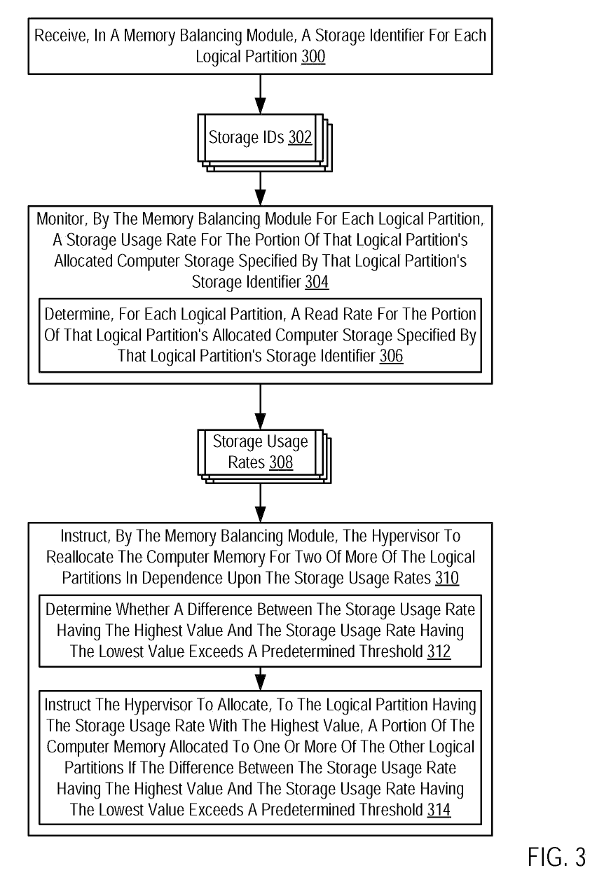

For further explanation, FIG. 3 sets forth a flow chart illustrating an exemplary method for balancing computer memory among a plurality of logical partitions on a computing system according to embodiments of the present invention. The computing system described with reference to FIG. 3 has installed upon it a hypervisor. The hypervisor has allocated computer memory and computer storage to each of the logical partitions established by the hypervisor.

The method of FIG. 3 includes receiving (300), in a memory balancing module, a storage identifier (302) for each logical partition established in the computing system. Each storage identifier (302) specifies a portion of a logical partition's allocated computer storage to be used for caching data contained in the logical partition's allocated computer memory. The memory balancing module may receive (300) a storage identifier (302) for each logical partition established in the computing system according to the method of FIG. 3 by reading the storage identifiers (302) from a configuration file established by a system administrator. In such an example, the system administrator may pre-configure certain portions of each partition's computer storage for monitor activity that the memory balancing module uses to balance computer memory among the logical partitions. Such monitored activity may include memory swapping, memory caching, or other computer storage activity. Swapping, also referred to as paging, is an important part of virtual memory implementations in most contemporary general-purpose operating systems because it allows the operating system to easily use disk storage for data that does not fit into physical RAM.

In other embodiments, the memory balancing module may receive (300) a storage identifier (302) for each logical partition established in the computing system according to the method of FIG. 3 by dynamically receiving the storage identifiers from the operating systems in each partition. In such an example, the operating systems dynamically allocate certain portions of each partition's computer storage for monitored activity that the memory balancing module uses to balance computer memory among the logical partitions. Upon allocating a portion of computer storage for monitored activity, each operating system may provide the memory balancing module with the storage identifier for the portion of computer storage allocated for the activity used to balance the computer memory among the logical partitions.

For example, consider that a computing system's hypervisor has established three logical partitions and allocated computer storage to each of the logical partitions. Further consider that the operating system for each partition designates a portion of that partition's computer storage as a swap area for use in memory swapping. In such an example, the storage identifiers (302) of FIG. 3 may specify the portion of each partition's computer storage used for memory swapping.

The method of FIG. 3 also includes monitoring (304), by the memory balancing module for each logical partition, a storage usage rate (308) for the portion of that logical partition's allocated computer storage specified by that logical partition's storage identifier (302). The storage usage rate (308) of FIG. 3 represents a usage statistic for the portion of the computer storage allocated to a logical partition for use by the partition in storage activity that the memory balancing module uses to balance computer memory among the logical partitions. As mentioned above, such storage activity may include reading or writing to swap areas or areas of the computer storage designated for caching data stored in main memory. Higher storage usage rates for the portion of a partition's computer storage designated for such storage activity indicate that allocating additional computer memory may be beneficial to enhance partition processing.

In the method of FIG. 3, the memory balancing module monitors (304) a storage usage rate (308) for each logical partition by determining (306), for each logical partition, a read rate for the portion of that logical partition's allocated computer storage specified by that logical partition's storage identifier. The memory balancing module may determine (306), for each logical partition, a read rate for the portion of that logical partition's allocated computer storage specified by that logical partition's storage identifier according to the method of FIG. 3 by retrieving the read rate for the specified computer storage portion from performance metrics stored in a SAN switch through which the computing system accesses the computer storage. In other embodiments, the memory balancing module may determine (306), for each logical partition, a read rate for the portion of that logical partition's allocated computer storage specified by that logical partition's storage identifier according to the method of FIG. 3 by retrieving the read rate for the specified computer storage portion from performance metrics maintained by a virtual I/O server installed on the computing system. As mentioned above, the virtual I/O server may be used to virtualize storage resources that provide computer storage to each logical partition. Readers will note that determining the read rate in the method of FIG. 3 is for explanation only and not for limitation. In other embodiments, the write rate to the portion of computer storage specified by the storage identifiers may also be used.

The method of FIG. 3 includes instructing (310), by the memory balancing module, the hypervisor to reallocate the computer memory for two or more of the logical partitions in dependence upon the storage usage rates (308). The memory balancing module may instruct (310) the hypervisor to reallocate the computer memory for two or more of the logical partitions according to the method of FIG. 3 by determining (312) whether a difference between the storage usage rate (308) having the highest value and the storage usage rate (308) having the lowest value exceeds a predetermined threshold and instructing (314) the hypervisor to allocate, to the logical partition having the storage usage rate (308) with the highest value, a portion of the computer memory allocated to one or more of the other logical partitions if the difference between the storage usage rate (308) having the highest value and the storage usage rate (308) having the lowest value exceeds a predetermined threshold. The predetermined threshold may be established by a system administer and stored in a configuration file for the memory balancing module.

For example, consider the logical partitions described in the following table 1:

TABLE 1

| LOGICAL | | STORAGE |
|---|---|---|
| PARTITION ID | ALLOCATED MEMORY | USAGE RATE |
| 0 | 8 GB | 10 MB/s |
| 1 | 4 GB | 40 MB/s |
| 2 | 3 GB | 60 MB/s |
| 3 | 1 GB | 120 MB/s |

The table 1 above describes four logical partitions-partition ‘0,’ partition ‘1,’ partition ‘2,’ and partition ‘3.’ For each logical partition, the table 1 above describes the amount of computer memory allocated to that logical partition in Gigabytes (‘GB’) and the storage usage rate in Megabytes per second (‘MB/s’) for the portion of that logical partition's allocated computer storage to be used for caching data contained in that logical partition's allocated computer memory. In the table 1 above, the difference between the storage usage rate having the highest value, 120 MB/s, and the storage usage rate having the lowest value, 10 MB/s, is 110 MB/s. For this example, consider that the predetermined threshold is 60 MB/s. Because the difference of 110 MB/s exceeds the predetermined threshold of 60 MB/s, the memory balancing module may instruct the hypervisor to allocate, to logical partition ‘3’ a portion of the computer memory allocated to one or more of the logical partitions ‘0,’ ‘1,’ and ‘2’.

In the exemplary method of FIG. 3, the memory balancing module may instruct (314) the hypervisor to allocate, to the logical partition having the storage usage rate (308) with the highest value, a portion of the computer memory allocated to one or more of the other logical partitions by calculating new computer memory allocation values for each of the partitions and invoking a function exposed by the hypervisor's API to provide the hypervisor with new computer memory allocation values. Upon receiving the new computer memory allocation values, the hypervisor then reallocates the computer memory among the logical partitions according to the new values provided to the hypervisor from the memory balancing module.

In the exemplary method of FIG. 3, the memory balancing module may calculate new computer memory allocation values for each of the partitions by determining a beneficiary allocation amount for the logical partition having the storage usage rate with the highest value. The beneficiary allocation amount is the amount of computer memory to be reallocated from the other logical partitions to the logical partition having the storage usage rate with the highest value. The beneficiary allocation amount for a logical partition may be implemented as percentage of the current amount of computer memory allocated to the partition. Continuing with the exemplary partitions described in the table 1 above, for example, the beneficiary allocation amount for a logical partition may be implemented as fifty percent of the current amount of computer memory allocated to the partition having the storage usage rate with the highest value—that is, fifty percent of 1 GB, which is 500 MB. Readers will note that implementing the beneficiary allocation amount for a logical partition as percentage of the current amount of computer memory allocated to the partition is for explanation only and not for limitation. Other ways of implementing the beneficiary allocation amount as will occur to those of skill in the art are also within the scope of the present invention such as, for example, implementing the beneficiary allocation amount as a fixed amount.

The memory balancing module may further calculate new computer memory allocation values for each of the partitions according to the method of FIG. 3 by, iteratively for each of the other logical partitions from the other logical partition having the storage usage rate with the lowest value to the other logical partition having the storage usage rate with the highest value, until the portion of the computer memory allocated matches the beneficiary allocation amount:
identifying a currently available amount for the computer memory allocated to the other logical partition;
determining the benefactor allocation amount for the computer memory allocated to the other logical partition;
identifying the portion of the computer memory allocated to the other logical partition to allocate to the logical partition having the disk usage rate with the highest value in dependence upon the currently available amount, the benefactor allocation amount, and the predefined beneficiary allocation amount; and
instructing the hypervisor to allocate the identified portion of the computer memory allocated to the other logical partition to the logical partition.

The steps above are iteratively performed for each of the other logical partitions from partitions from the other logical partition having the storage usage rate with the lowest value to the other logical partition having the storage usage rate with the highest value until the portion of the computer memory allocated matches the beneficiary allocation amount. For example, continuing with the exemplary logical partitions described in the table 1 above and an exemplary beneficiary allocation amount of 500 MB, the bulleted step above are performed for each of the partitions in the order of partition ‘0,’ partition ‘1,’ and then partition ‘2’ until the portion of the computer memory allocated partitions ‘0,’ ‘1,’ and ‘2’ matches 500 MB. The currently available amount for the computer memory allocated to a logical partition is the amount of computer memory that is not currently being utilized by the logical partition. The memory balancing module may identify a currently available amount for the computer memory allocated to each of other logical partitions by calculating the difference between the allocated computer memory amount and the currently utilized computer memory amount for each partition. For example, consider that a logical partition is allocated 4 GB of computer memory and currently utilizes only 3 GB of the allocated computer memory. The currently available amount for the computer memory allocated to that exemplary logical partition is the difference between the allocated amount and the currently utilized amount—that is, the difference between 4 GB and 3 GB, which is 1 GB.

The benefactor allocation amount is the amount of computer memory to be reallocated from one of the other logical partitions to the logical partition having the storage usage rate with the highest value. The memory balancing module may determine the benefactor allocation amount for the computer memory allocated to the other logical partition by calculating the benefactor allocation amount as a percentage of the current amount of computer memory allocated to the partition. For example, continuing with the exemplary partitions described in the table 1 above, the benefactor allocation amount for logical partition 0 may be implemented as ten percent of the current amount of computer memory allocated to partition ‘0’—that is, ten percent of 8 GB, which is 800 MB. Readers will note that implementing the benefactor allocation amount for a logical partition as a percentage of the current amount of computer memory allocated to a partition is for explanation only and not for limitation. Other ways of implementing the benefactor allocation amount as will occur to those of skill in the art are also within the scope of the present invention such as, for example, implementing the benefactor allocation amount as a fixed amount.

The memory balancing module may identify the portion of the computer memory allocated to the other logical partition to allocate to the logical partition having the disk usage rate with the highest value by calculating the amount of computer memory to allocate as the minimum of the currently available amount, the benefactor allocation amount, and the predefined beneficiary allocation amount. Continuing with the exemplary currently available amount of 1 GB, the exemplary benefactor allocation amount of 800 MB, and the exemplary beneficiary allocation amount of 500 MB, the memory balancing module may identify the portion of the computer memory allocated to logical partition ‘0’ to allocate to the logical partition ‘3’ by calculating the amount of computer memory to allocate as 500 MB.

The memory balancing module may then instruct the hypervisor to allocate the identified portion of the computer memory allocated to the other logical partition to the logical partition by calculating new computer memory allocation values for each of the partitions based on the identified portion of the computer memory and invoking a function exposed by the hypervisor's API to provide the hypervisor with new computer memory allocation values. Using the identify the portion of the computer memory of 500 MB for partition ‘0’ in the example above, the memory balancing module may calculate new computer memory allocation values for each of the partitions as described in the following exemplary table 2:

TABLE 2

| LOGICAL PARTITION ID | NEW ALLOCATION VALUES |
|---|---|
| 0 | 7.5 GB |
| 1 | 4 GB |
| 2 | 3 GB |
| 3 | 1.5 GB |

Readers will note from table 2 above that the memory balancing module instructs the hypervisor to reallocate 500 MB from partition ‘0’ to partition ‘3.’

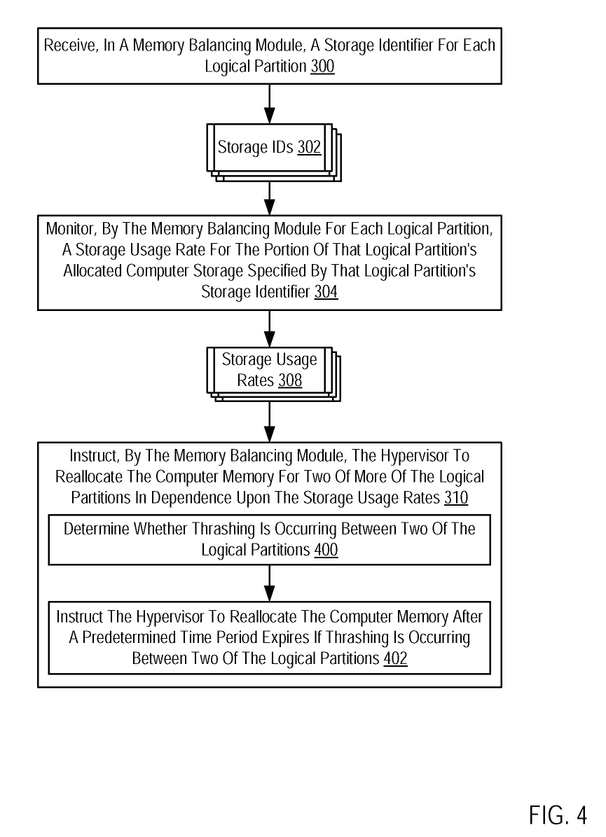

As the memory balancing module balances computer memory among a plurality of logical partitions on a computing system, occasionally, thrashing will occur between logical partitions. Thrashing refers to a scenario in which the memory balancing module reallocates computer memory from a first logical partition to a second logical partition because the first partition has excess computer memory resources when compared to the second partition. Upon reallocating computer memory from the first logical partition to the second logical partition, the second partition now has excess computer memory resources when compared to the first partition, which in turn causes the memory balancing module to reallocate computer memory from the second partition to the first partition. Upon reallocating computer memory from the second logical partition to the first logical partition, the first partition again has excess computer memory resources when compared to the second partition, which in turn causes the memory balancing module to reallocate computer memory from the first partition to the second partition. The repetition of this cycle is referred to as thrashing. For further explanation of how the memory balancing module may administer thrashing, FIG. 4 sets forth a flow chart illustrating a further exemplary method for balancing computer memory among a plurality of logical partitions on a computing system according to embodiments of the present invention. The computing system described with reference to FIG. 4 has installed upon it a hypervisor. The hypervisor has allocated computer memory and computer storage to each of the logical partitions established by the hypervisor.

The method of FIG. 4 is similar to the method of FIG. 3. That is, the method of FIG. 4 includes: receiving (300), in a memory balancing module, a storage identifier (302) for each logical partition, the storage identifier (302) specifying a portion of a logical partition's allocated computer storage to be monitored; monitoring (304), by the memory balancing module for each logical partition, a storage usage rate (308) for the portion of that logical partition's allocated computer storage specified by that logical partition's storage identifier (302); and instructing (310), by the memory balancing module, the hypervisor to reallocate the computer memory for two or more of the logical partitions in dependence upon the storage usage rates (308).

The method of FIG. 4 differs from the method of FIG. 3 in that instructing (310), by the memory balancing module, the hypervisor to reallocate the computer memory for two or more of the logical partitions in dependence upon the storage usage rates (308) according to the method of FIG. 4 includes determining (400) whether thrashing is occurring between two of the logical partitions and instructing (402) the hypervisor to reallocate the computer memory after a predetermined time period expires if thrashing is occurring between two of the logical partitions. The memory balancing module may determine (400) whether thrashing is occurring between two of the logical partitions according to the method of FIG. 4 by tracking historical computer memory allocation information and comparing the current instructions to reallocate computer memory with historical computer memory allocation information. If such a comparison indicates that a similar amount of computer memory have been reallocated back and forth between the same two logical partitions for a number of times that exceeds a predefined threshold, then thrashing is occurring between the two logical partitions.

If thrashing is occurring between two of the logical partitions, the memory balancing module may the instruct (402) the hypervisor to reallocate the computer memory after a predetermined time period expires by setting a timer with a value that matches the predetermined time period and instructing the hypervisor to reallocate the computer memory after the timer reaches a value of zero. Readers will note that instructing the hypervisor to reallocate the computer memory for two or more of the logical partitions in a manner that reduces thrashing by instructing the hypervisor to reallocate the computer memory after a predetermined time period expires is for explanation only and not for limitation. In fact, other ways of instructing the hypervisor to reallocate the computer memory for two or more of the logical partitions in a manner that reduces thrashing as will occur to those of skill in the art are also within the scope of the present invention such as, for example, increasing the predetermined threshold that the difference between the storage usage rate having the highest value and the storage usage rate having the lowest value must exceed before instructing the hypervisor to reallocate computer memory among logical partitions.

Exemplary embodiments of the present invention are described largely in the context of a fully functional computer system for balancing computer memory among a plurality of logical partitions on a computing system. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of balancing computer memory among a plurality of logical partitions on a computing system, the computing system having installed upon it a hypervisor, the hypervisor having allocated computer memory and computer storage to each of the logical partitions, the method comprising:
receiving, in a memory balancing module, a storage identifier for each logical partition, the storage identifier specifying a portion of a logical partition's allocated computer storage to be used for caching data contained in the logical partition's allocated computer memory;
monitoring, by the memory balancing module for each logical partition, a storage usage rate for the portion of that logical partition's allocated computer storage specified by that logical partition's storage identifier; and
instructing, by the memory balancing module, the hypervisor to reallocate the computer memory for two or more of the logical partitions in dependence upon the storage usage rates.

2. The method of claim 1 wherein monitoring, by the memory balancing module for each logical partition, a storage usage rate for the portion of that logical partition's allocated computer storage specified by that logical partition's storage identifier further comprises determining, for each logical partition, a read rate for the portion of that logical partition's allocated computer storage specified by that logical partition's storage identifier.

3. The method of claim 1 wherein instructing, by the memory balancing module, the hypervisor to reallocate the computer memory for two or more of the logical partitions in dependence upon the storage usage rates further comprises:
determining whether a difference between the storage usage rate having the highest value and the storage usage rate having the lowest value exceeds a predetermined threshold; and
instructing the hypervisor to allocate, to the logical partition having the storage usage rate with the highest value, a portion of the computer memory allocated to one or more of the other logical partitions if the difference between the storage usage rate having the highest value and the storage usage rate having the lowest value exceeds a predetermined threshold.

4. The method of claim 3 wherein instructing the hypervisor to allocate, to the logical partition having the storage usage rate with the highest value, a portion of the computer memory allocated to one or more of the other logical partitions further comprises:
determining a beneficiary allocation amount for the logical partition having the storage usage rate with the highest value; and
iteratively for each of the other logical partitions, from the other logical partition having the storage usage rate with the lowest value to the other logical partition having the storage usage rate with the highest value, until the portion of the computer memory allocated matches the beneficiary allocation amount:
identifying a currently available amount for the computer memory allocated to the other logical partition,
determining the benefactor allocation amount for the computer memory allocated to the other logical partition,
identifying the portion of the computer memory allocated to the other logical partition to allocate to the logical partition having the disk usage rate with the highest value in dependence upon the currently available amount, the benefactor allocation amount, and the predefined beneficiary allocation amount, and
instructing the hypervisor to allocate the identified portion of the computer memory allocated to the other logical partition to the logical partition.

5. The method of claim 1 wherein instructing, by the memory balancing module, the hypervisor to reallocate the computer memory for two or more of the logical partitions in dependence upon the storage usage rates further comprises:
determining whether thrashing is occurring between two of the logical partitions; and
instructing the hypervisor to reallocate the computer memory after a predetermined time period expires if thrashing is occurring between two of the logical partitions.

6. The method of claim 1 wherein the portion of each logical partition's allocated computer storage specified by that logical partition's storage identifier is that logical partition's swap area.

7. Apparatus for balancing computer memory among a plurality of logical partitions on a computing system, the computing system having installed upon it a hypervisor, the hypervisor having allocated computer memory and computer storage to each of the logical partitions, the apparatus comprising a computer processor, a computer memory operatively coupled to the computer processor, the computer memory having disposed within it computer program instructions capable of:
receiving, in a memory balancing module, a storage identifier for each logical partition, the storage identifier specifying a portion of a logical partition's allocated computer storage to be used for caching data contained in the logical partition's allocated computer memory;
monitoring, by the memory balancing module for each logical partition, a storage usage rate for the portion of that logical partition's allocated computer storage specified by that logical partition's storage identifier; and
instructing, by the memory balancing module, the hypervisor to reallocate the computer memory for two or more of the logical partitions in dependence upon the storage usage rates.

8. The apparatus of claim 7 wherein monitoring, by the memory balancing module for each logical partition, a storage usage rate for the portion of that logical partition's allocated computer storage specified by that logical partition's storage identifier further comprises determining, for each logical partition, a read rate for the portion of that logical partition's allocated computer storage specified by that logical partition's storage identifier.

9. The apparatus of claim 7 wherein instructing, by the memory balancing module, the hypervisor to reallocate the computer memory for two or more of the logical partitions in dependence upon the storage usage rates further comprises:
determining whether a difference between the storage usage rate having the highest value and the storage usage rate having the lowest value exceeds a predetermined threshold; and
instructing the hypervisor to allocate, to the logical partition having the storage usage rate with the highest value, a portion of the computer memory allocated to one or more of the other logical partitions if the difference between the storage usage rate having the highest value and the storage usage rate having the lowest value exceeds a predetermined threshold.

10. The apparatus of claim 9 wherein instructing the hypervisor to allocate, to the logical partition having the storage usage rate with the highest value, a portion of the computer memory allocated to one or more of the other logical partitions further comprises:
determining a beneficiary allocation amount for the logical partition having the storage usage rate with the highest value; and
iteratively for each of the other logical partitions, from the other logical partition having the storage usage rate with the lowest value to the other logical partition having the storage usage rate with the highest value, until the portion of the computer memory allocated matches the beneficiary allocation amount:
identifying a currently available amount for the computer memory allocated to the other logical partition,
determining the benefactor allocation amount for the computer memory allocated to the other logical partition,
identifying the portion of the computer memory allocated to the other logical partition to allocate to the logical partition having the disk usage rate with the highest value in dependence upon the currently available amount, the benefactor allocation amount, and the predefined beneficiary allocation amount, and
instructing the hypervisor to allocate the identified portion of the computer memory allocated to the other logical partition to the logical partition.

11. The apparatus of claim 7 wherein instructing, by the memory balancing module, the hypervisor to reallocate the computer memory for two or more of the logical partitions in dependence upon the storage usage rates further comprises:
determining whether thrashing is occurring between two of the logical partitions; and
instructing the hypervisor to reallocate the computer memory after a predetermined time period expires if thrashing is occurring between two of the logical partitions.

12. The apparatus of claim 7 wherein the portion of each logical partition's allocated computer storage specified by that logical partition's storage identifier is that logical partition's swap area.

13. A computer program product for balancing computer memory among a plurality of logical partitions on a computing system, the computing system having installed upon it a hypervisor, the hypervisor having allocated computer memory and computer storage to each of the logical partitions, the computer program product disposed in a computer readable medium, the computer program product comprising computer program instructions capable of:
receiving, in a memory balancing module, a storage identifier for each logical partition, the storage identifier specifying a portion of a logical partition's allocated computer storage to be used for caching data contained in the logical partition's allocated computer memory;
monitoring, by the memory balancing module for each logical partition, a storage usage rate for the portion of that logical partition's allocated computer storage specified by that logical partition's storage identifier; and
instructing, by the memory balancing module, the hypervisor to reallocate the computer memory for two or more of the logical partitions in dependence upon the storage usage rates.

14. The computer program product of claim 13 wherein monitoring, by the memory balancing module for each logical partition, a storage usage rate for the portion of that logical partition's allocated computer storage specified by that logical partition's storage identifier further comprises determining, for each logical partition, a read rate for the portion of that logical partition's allocated computer storage specified by that logical partition's storage identifier.

15. The computer program product of claim 13 wherein instructing, by the memory balancing module, the hypervisor to reallocate the computer memory for two or more of the logical partitions in dependence upon the storage usage rates further comprises:
determining whether a difference between the storage usage rate having the highest value and the storage usage rate having the lowest value exceeds a predetermined threshold; and
instructing the hypervisor to allocate, to the logical partition having the storage usage rate with the highest value, a portion of the computer memory allocated to one or more of the other logical partitions if the difference between the storage usage rate having the highest value and the storage usage rate having the lowest value exceeds a predetermined threshold.

16. The computer program product of claim 15 wherein instructing the hypervisor to allocate, to the logical partition having the storage usage rate with the highest value, a portion of the computer memory allocated to one or more of the other logical partitions further comprises:
determining a beneficiary allocation amount for the logical partition having the storage usage rate with the highest value; and
iteratively for each of the other logical partitions, from the other logical partition having the storage usage rate with the lowest value to the other logical partition having the storage usage rate with the highest value, until the portion of the computer memory allocated matches the beneficiary allocation amount:
identifying a currently available amount for the computer memory allocated to the other logical partition,
determining the benefactor allocation amount for the computer memory allocated to the other logical partition,
identifying the portion of the computer memory allocated to the other logical partition to allocate to the logical partition having the disk usage rate with the highest value in dependence upon the currently available amount, the benefactor allocation amount, and the predefined beneficiary allocation amount, and
instructing the hypervisor to allocate the identified portion of the computer memory allocated to the other logical partition to the logical partition.

17. The computer program product of claim 13 wherein instructing, by the memory balancing module, the hypervisor to reallocate the computer memory for two or more of the logical partitions in dependence upon the storage usage rates further comprises:
determining whether thrashing is occurring between two of the logical partitions; and
instructing the hypervisor to reallocate the computer memory after a predetermined time period expires if thrashing is occurring between two of the logical partitions.

18. The computer program product of claim 13 wherein the portion of each logical partition's allocated computer storage specified by that logical partition's storage identifier is that logical partition's swap area.

19. The computer program product of claim 13 wherein the computer readable medium comprises a recordable medium.

20. The computer program product of claim 13 wherein the computer readable medium comprises a transmission medium.
